(19) United States
(12) Patent Application Publication
(10) Pub. No.: US 2018/0190024 A1
(43) Pub. Date: Jul. 5, 2018

(54) SPACE BASED CORRELATION TO AUGMENT USER EXPERIENCE

(71) Applicants: Therese E. Dugan, Sunnyvale, CA (US); Katherine E. Mills, Portland, OR (US); Glen J. Anderson, Beaverton, OR (US); Meng Shi, Hillsboro, OR (US); John Gaffrey, Hillsboro, OR (US); David I. Poisner, Carmichael, CA (US)

(72) Inventors: Therese E. Dugan, Sunnyvale, CA (US); Katherine E. Mills, Portland, OR (US); Glen J. Anderson, Beaverton, OR (US); Meng Shi, Hillsboro, OR (US); John Gaffrey, Hillsboro, OR (US); David I. Poisner, Carmichael, CA (US)

(21) Appl. No.: 15/395,629

(22) Filed: Dec. 30, 2016

(51) Int. Cl. G06T 19/00; G06K 9/00

(52) U.S. Cl. CPC G06T 19/006; G06K 9/00671

(57) ABSTRACT

Systems, apparatuses, and/or methods to augment a user experience. A correlater may correlate a physical three-dimensional (3D) play space and a setting space of media content. An augmenter may augment the media content based on a change in the physical 3D play space. An augmenter may augment the physical 3D play space based on a change in the setting space.

### TECHNICAL FIELD

Embodiments generally relate to augmenting a user experience. More particularly, embodiments relate to augmenting a user experience based on a correlation between a user play space and a setting space of media content.

### BACKGROUND

Media, such as a television show, may have a connection with physical toy characters so that actions of characters in a scene may be correlated to actions of real toy figures with sensors and actuators. Moreover, a two-dimensional surface embedded with near-field communication (NFC) tags may allow objects to report their location to link to specific scenes in media. Additionally, augmented reality characters may interact with a streamed program to change scenes in the streamed program. In addition, block assemblies may be used to create objects onscreen. Thus, there is considerable room for improvement to augment a user experience based on a correlation between a user play space and a setting space in media content consumed by a user.

### BRIEF DESCRIPTION OF THE DRAWINGS

The various advantages of the embodiments will become apparent to one skilled in the art by reading the following specification and appended claims, and by referencing the following drawings, in which:

FIGS. 1A-1C are illustrations of an example of a system to augment a user experience according to an embodiment;

FIG. 2 is an illustration of an example augmentation service according to an embodiment;

FIG. 3 is an illustration of an example of a method to augment a user experience according to an embodiment;

FIG. 4 is a block diagram of an example of a processor according to an embodiment; and

FIG. 5 is a block diagram of an example of a computing system according to an embodiment.

### DESCRIPTION OF EMBODIMENTS

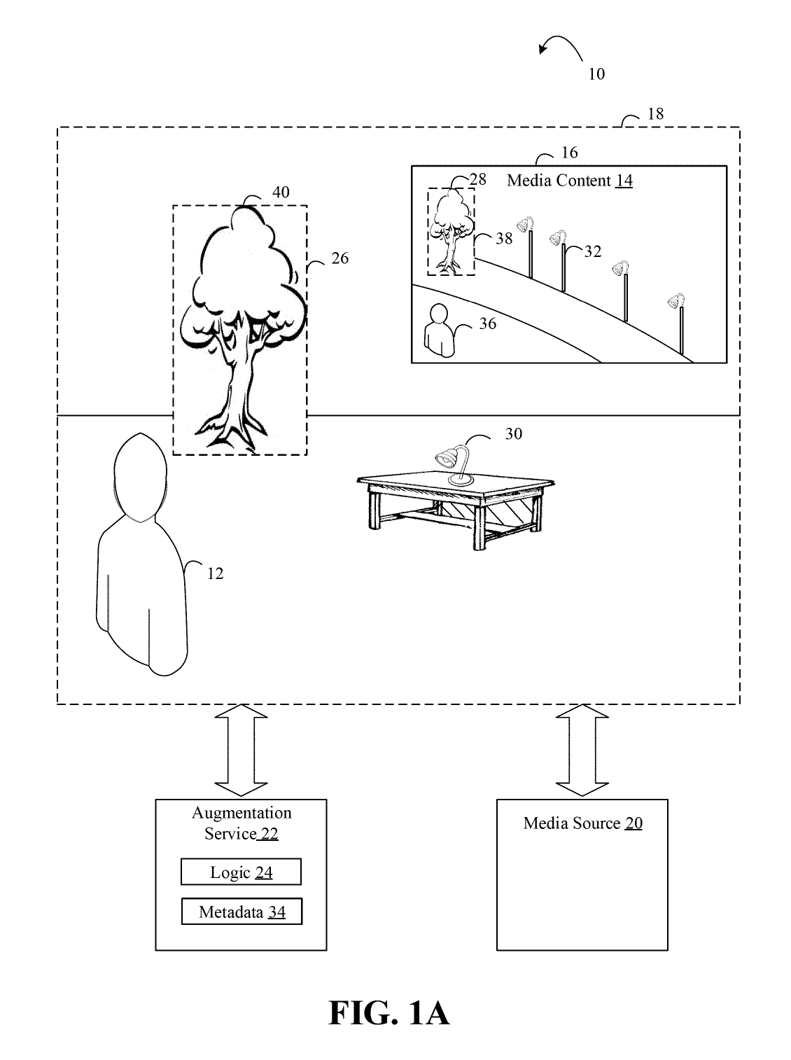

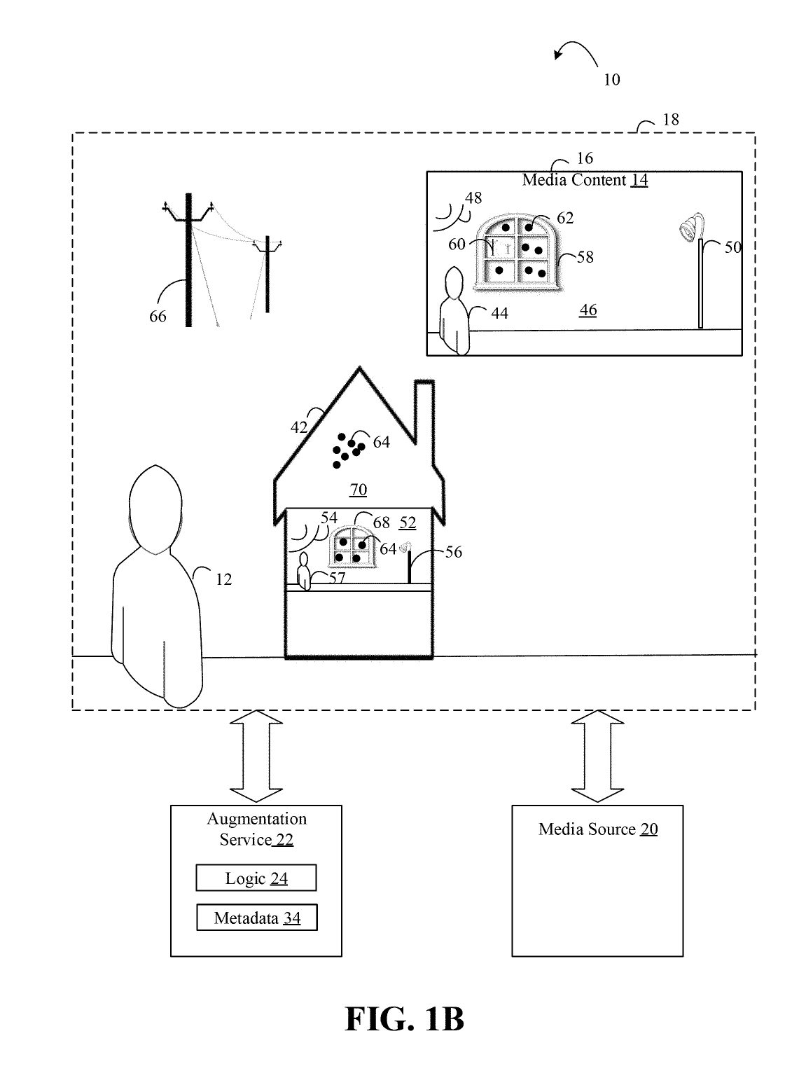

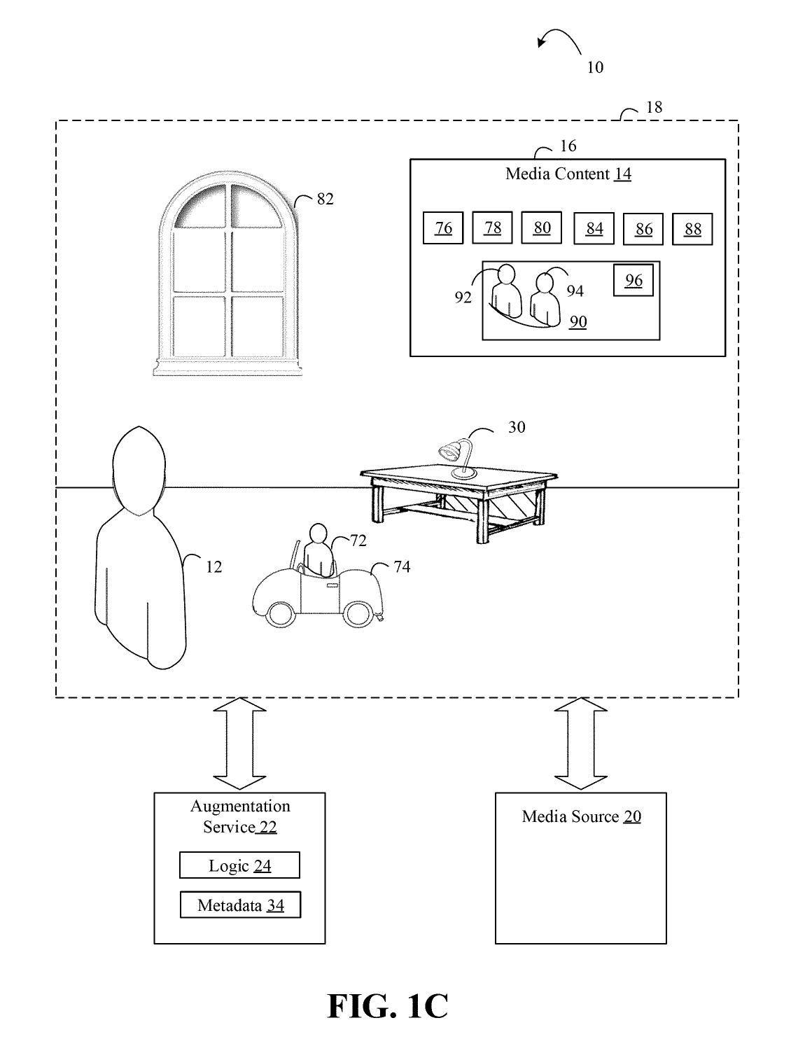

Turning now to FIGS. 1A-1C, a system 10 is shown to augment a user experience according to an embodiment. As shown in FIG. 1A, a consumer 12 views media content 14 via a computing platform 16 in a physical space 18 (e.g., a family room, a bedroom, a play room, etc.) of the consumer 12. The media content 14 may include a live television (TV) show, a pre-recorded TV show that is aired for the first time and/or that is replayed (e.g., on demand, etc.), a video streamed from an online content provider, a video played from a storage medium, a music concert, content having a virtual character, content having a real character, and so on. In addition, the computing platform 16 may include a laptop, a personal digital assistant (PDA), a media content player (e.g., a receiver, a set-top box, a media drive, etc.), a mobile Internet device (MID), any smart device such as a wireless smart phone, a smart tablet, a smart TV, a smart watch, smart glasses (e.g., augmented reality (AR) glasses, etc.), a gaming platform, and so on.

The computing platform 16 may also include communication functionality for a wide variety of purposes such as, for example, cellular telephone (e.g., Wideband Code Division Multiple Access/W-CDMA (Universal Mobile Telecommunications System/UMTS), CDMA2000 (IS-856/IS-2000), etc.), WiFi (Wireless Fidelity, e.g., Institute of Electrical and Electronics Engineers/IEEE 802.11-2007, Wireless Local Area Network/LAN Medium Access Control (MAC) and Physical Layer (PHY) Specifications), LiFi (Light Fidelity, e.g., Institute of Electrical and Electronics Engineers/IEEE 802.15-7, Wireless Local Area Network/LAN Medium Access Control (MAC) and Physical Layer (PHY) Specifications), 4G LTE (Fourth Generation Long Term Evolution), Bluetooth (e.g., Institute of Electrical and Electronics Engineers/IEEE 802.15.1-2005, Wireless Personal Area Networks), WiMax (e.g., IEEE 802.16-2004, LAN/MAN Broadband Wireless LANS), Global Positioning System (GPS), spread spectrum (e.g., 900 MHz), NFC (Near Field Communication, ECMA-340, ISO/IEC 18092), and other radio frequency (RF) purposes. Thus, the computing platform 16 may utilize the communication functionality to receive the media content 14 from a media source 20 (e.g., data storage, a broadcast network, an online content provider, etc.).

The system 10 further includes an augmentation service 22 to augment the experience of the consumer 12. The augmentation service 22 may have logic 24 (e.g., logic instructions, configurable logic, fixed-functionality logic hardware, etc.) configured to implement any of the herein mentioned technologies including to correlate, to augment, to determine metadata, to encode/decode, to delineate, to render, and so on.

For example, the augmentation service 22 may correlate a physical three-dimensional (3D) play space of the consumer 12 with a setting space of the media content 14. A physical 3D play space may be, for example, the physical space 18, a real object in the physical space 18 that accommodates real objects, that accommodates virtual objects, and so on. As shown in FIG. 1A, the play space 18 is a physical 3D play space that accommodates the consumer 12, that accommodates the computing platform 16, and so on. A setting space of the media content 14 may be a real space that is captured (e.g., via an image capturing device, etc.) and that accommodates a real object. The setting space of the media content 14 may also be a virtual space that accommodates a virtual object. In one example, the virtual space may include computer animation that involves 3D computer graphics, with or without two-dimensional (2D) graphics, including a 3D cartoon, a 3D animated object, and so on.

The augmentation service 22 may correlate a physical 3D play space and a setting space before scene runtime. In one example, a correlation may include a 1:1 mapping between a physical 3D play space and a setting space (including objects therein). The augmentation service 22 may, for example, map a room of a dollhouse with a set of a room in a TV show at scene production time, at play space fabrication time, and so on. The augmentation service 22 may also map a physical 3D play space and a setting space at scene runtime. For example, the augmentation service 22 may determine a figure is introduced into a physical 3D play space (e.g., using an identifier associated with the figure, etc.) and map the figure with a character in a setting space when the media content 14 plays. The augmentation service 22 may also determine a physical 3D play space is built (e.g., via object/model recognition, etc.) in a physical space and map a physical 3D play space to a setting space based on the model construction/recognition. As shown in FIG. 1A, the augmentation service 22 maps the physical space 18 with a setting space of the media content 14 (e.g., set of a scene, etc.). For example, the augmentation service 22 maps a particular area 26 of the physical space 18 with a particular area 28 of a setting space of the media content 14.

Moreover, the augmentation service 22 may delineate a physical 3D play space to correlate a physical 3D play space and a setting space. For example, the augmentation service 22 may scale a dimension of a physical 3D play space with a dimension of a setting space (e.g., scale to match), before and/or during runtime. Scaling may be implemented to match what happened in a scene of the media content 14 to a dimension of usable space in a physical 3D play space (e.g., how to orient it, if there is a window in a child's bedroom, how to anchor it, etc.). As shown in FIG. 1A, the augmentation service 22 scales the physical space 18 with the setting space of the media content 14, such that a dimension (e.g., height, width, depth, etc.) of the particular area 26 is scaled to a dimension (e.g., height, etc.) of the particular area 28.

The augmentation service 22 may also determine a reference point of a physical 3D play space, before and/or during runtime, to correlate a physical 3D play space and a setting space. As shown in FIG. 1A, the augmentation service 22 may determine that a fixture 30 (e.g., a lamp) in the physical space 18 is mapped with a fixture 32 (e.g., a lamp) in the setting space of the media content 14. Thus, the fixture 30 may operate as a central reference point about which a scene in the media content 14 plays.

The augmentation service 22 may further determine metadata for a setting space, before and/or during runtime, to correlate a physical 3D play space and a setting space. For example, the augmentation service 22 may determine metadata 34 for a setting space while the media content 14 is being cued (e.g., from a guide, etc.), and may correlate the physical space 18 with the setting space at runtime based on the metadata 34. The metadata 34 may also be created during production and/or during post-production manually, automatically (e.g., via object recognition, spatial recognition, machine learning, etc.), and so on.

The metadata 34 may include setting metadata such as, for example, setting dimensions, colors, lighting, and so on. Thus, physicality of spaces may be part of setting metadata and used in mapping to physical play experiences (e.g., part of bedroom is sectioned off to match a scene in a show). For example, the augmentation service 22 may use a 3D camera (e.g., a depth camera, a range image camera, etc.) and/or may access dimensional data (e.g., when producing the content, etc.), and stamp dimensions for that scene (e.g., encode the metadata into a frame, etc.). The augmentation service 22 may also provide an ongoing channel/stream of metadata (e.g., setting metadata, etc.) moment to moment in the media content 14 (e.g., via access to a camera angle that looks at a different parts of a scene, and that dimensional data may be embedded in the scene, etc.).

The metadata 34 may further include effect metadata such as, for example, thunder, rain, snow, engine rev, and so on. For example, the augmentation service 22 may map audio to a physical 3D play space to allow a user to experience audio realistically (e.g., echo, muffled, etc.) within a correlated space. In one example, a doorbell may ring in a TV show and the augmentation service 22 may use the audio effect metadata to map the ring in the TV who with an accurate representation in the physical space 18. In another example, directed audio output (e.g., via multiple speakers, etc.) may be generated to allow audio to seem to originate and/or to originate from a particular location (e.g., a sound of a car engine tuning on may come from a garage of a dollhouse, etc.). Additionally, the augmentation service 22 may determine activity metadata for a character in a setting space. For example, the augmentation service 22 may determine character activity that plays within a scene and add the activity metadata to that scene (e.g., proximity of characters to each other, character movement, etc.).

The metadata 34 may further include control metadata such as, for example, an instruction that is to be issued to the consumer 12. For example, the augmentation service 22 may indicate when to implement a pause operation and/or a resume play operation, a prompt (e.g., audio, visual, etc.) to complete a task, an observable output that is to be involved in satisfying an instruction (e.g., a virtual object that appears when a user completes a task such as moving a physical object, etc.), and so on. As shown in FIG. 1A, a character 36 in the media content 14 may instruct the consumer 12 to point to a tree 38. Space correlations may require the consumer 12 to point to where a virtual tree 40 (e.g., a projected virtual object, etc.) is located in the physical space 18 and not merely to the tree 38 in the media content 14. In this regard, the control metadata may include the prompt to point to a tree, may indicate that rendering of the media content 14 is to pause when the prompt is issued, may indicate that rendering of the media content 14 is to resume when the consumer 12 completes the task, and so on.

The metadata 34 may further determine metadata using an estimate. For example, the augmentation service 22 may compute estimates on existing video (e.g., TV show taped in the past, etc.) to recreate an environment, spatial relationships, sequences of actions/events, effects, and so on. In this regard, a 3D environment may be rendered based on those estimates (e.g., of distances, etc.) and encoded within that media content. Thus, existing media content may be analyzed and/or modified to include relevant data (e.g., metadata, etc.) via a codec to encode/decode the metadata in the media content 14.

Notably, the augmentation service 22 may utilize correlations (e.g., based on mapping data, metadata, delineation data, sensor data, etc.) to augment user experience. As further shown in FIG. 1B, the augmentation service 22 correlates a physical 3D play space 42 of the consumer 12, such as a real object (e.g., a dollhouse, etc.) in the physical space 18 that accommodates real objects, with a setting space 46 (e.g., a bedroom) of the media content 14, such as a physical set and/or a physical shooting location that is captured by an image capture device. In one example, the augmentation service 22 may correlate any or each room of a dollhouse with a corresponding room in a TV show, any or each figure in a dollhouse with a corresponding actor in the TV show, any or each fixture in a dollhouse with a corresponding fixture in the TV show, any or each piece of furniture in a dollhouse with a corresponding piece of furniture in the TV show, etc.

The media content 14 may, for example, include a scene where a character 44 walks into the bedroom 46, thunder 48 is heard, and light 50 in the bedroom 46 are turned off. The progression of the media content 14 may influence the physical 3D play space 42 when the augmentation service 22 uses the correlation between a specific room 52 and the bedroom 46 to cause the physical 3D play space 42 to play a thunderclap 54 (e.g., via local speakers, etc.) and turn light 56 off (e.g., via a local controller, etc.) in the specific room 52. The augmentation service 22 may, for example, cause the physical 3D play space 42 to provide observable output when the consumer 12 places a figure 57 (e.g., a toy figure, etc.) in the specific room 52 to emulate the scene in the media content 14.

Accordingly, the physical 3D play space 42 may include and/or may implement a sensor, an actuator, a controller, etc. to generate observable output. Notably, audio and/or video from the media content 14 may be detected directly from a sensor coupled with the physical 3D play space 42 (e.g., detect thunder, etc.). For example, a microphone of the physical 3D play space 42 may detect a theme song of the media content 14 to allow the consumer 12 to keep the scene (e.g., with play space activity). In addition, the augmentation service 22 may implement 3D audio mapping to allow sound to be experienced realistically (e.g., echo, etc.) within the physical 3D play space 42 (e.g., a doorbell might ring, and audio effects are mapped with 3D space). Play space activity (e.g., movement of a figure, etc.) may be detected in the physical 3D play space 42 via an image capture device (e.g., a camera, etc.), via wireless sensors (e.g., RF sensor, NFC sensor, etc.), and so on. Actuators and/or controllers may also actuate real objects (e.g., projectors, etc.) coupled with the physical 3D play space 42 to generate virtual output.

For example, the scene in the media content 14 may include the character 44 walking to a window 58 in the bedroom 46 and peering out to see a down utility line 60. The character 44 may also observe rain 62 on the window 58 and on a roof (not shown) as they look out of the window 58. The progression of the media content 14 may influence the physical 3D play space 42 when the augmentation service 22 uses the correlation between a window 68 in the specific room 52 and the window 58 in the bedroom 46 to cause the physical 3D play space 42 to project a virtual down utility line 66 (e.g., via actuation of a projector, etc.). The augmentation service 22 may, for example, cause the physical 3D play space 42 to provide observable output when the consumer 12 places the figure 57 in front of the window 68 to emulate the scene in the media content 14. In addition, the physical 3D play space 42 may project virtual rain 64 on the window 68 and on a roof 70 of the physical 3D play space 42.

While virtual observable output may be provided to augment user experience, real observable output may also be provided via actuators, controllers, etc. (e.g., water may be sprayed, 3D audio may be generated, etc.). Moreover, actuators in the play space 18 and/or the physical 3D play space 42 may cause a virtual object to be displayed in the physical space 18. For example, a virtual window in the physical space 18 that corresponds to the window 58 in the media content may be projected and display whatever the figure 44 observes when peering out of the window 58 in the media content 14. Thus, the consumer 12 may peer out of a virtual window in the physical space 18 to emulate the character 44, and see observable output as experienced by the character 44.

Additionally, the media content 14 may influence the activity of the consumer 12 when an instruction is issued to move the figure 57 to peer outside of the window 68, or to move the consumer 12 to peer outside of a virtual window in the physical space 18. Thus, missions may be issued to repeat tasks in the media content 14, to find a hidden object, etc., wherein a particular scene involving the task is played, is replayed, and so on. In one example, the consumer 12 may be directed to follow through a series of instructions (e.g., a task, etc.) that solves a riddle, achieves a goal, and so on.

As shown in FIG. 1C, the augmentation service 22 may determine a spatial relationship involving a figure 72 in a physical 3D play space 74 (e.g., automobile, etc.) that is to correspond to a particular scene 76 of the media content 14. For example, the consumer 12 may bring the figure 72 in a predetermined proximity to one other figure (e.g., passenger, etc.) in the physical 3D play space 74 that maps to a same spatial situation in the media content 14. In this regard, the play space activity in the physical 3D play space 72 may influence the progression of the media content 14 when the augmentation service 22 uses the correlation between seats, figures, etc., to map to the particular scene 76, to allow the consumer 12 to select from a plurality of scenes that have the two characters in same physical 3D play space 74 within certain proximity, etc.

The augmentation service 22 may further determine an action involving a real object in the physical 3D play space 74 that is to correspond to a particular scene 78 of the media content 14. For example, the consumer 12 may dress the figure 72 in the physical 3D play space 74 that maps to a same wardrobe situation in the media content 14. In this regard, the play space activity in the physical 3D play space 74 may influence the progression of the media content 14 when the augmentation service 22 uses the correlation between seats, figures, clothing, etc., to map to the particular scene 78, to allow the consumer 12 to select from a plurality of scenes that has the character in a same seat and that is dressed the same, and so on.

The augmentation service 22 may also determine an action involving a real object in the physical space 18 that is to correspond to a particular scene 80 of the media content 14, wherein the play space activity in the physical space 18 may influence the progression of the media content 14. In one example, a position of the consumer 12 relative to the lamp 30 in the physical space 18 may activate actuation within media content 14 to render the particular scene 80. In a further example, the consumer 12 may speak a particular line from the particular scene 80 of the media content 14 in a particular area of the physical space 18, such as while looking out of a real window 82, and the media content 14 may be activated to render the particular scene 80 based on correlations (e.g., character, position, etc.). In another example, the arrival of the consumer 12 in the physical space 18 (or area therein) may change a scene to the particular scene 80.

In addition, the physical 3D play space 74 may be constructed (e.g., a model is built, etc.) in the physical space 18 to map to a particular scene 84, to allow the consumer 12 to select from a plurality of scenes that has the physical 3D play space 74, and so on. Thus, a building block may be used to build a model, wherein the augmentation service 22 may utilize an electronic tracking system to determine what model was built and change a scene in the media content 14 to the particular scene 84 that includes the model (e.g., if you build a truck, a scene with truck is rendered, etc.). In one example, the physical 3D play space 74 may be constructed in response to an instruction issued by the media content 14 to complete a task of generating a model. Thus, the media content 14 may enter a pause state until the task is complete. The physical 3D play space 74 may also be constructed absent any prompt, for example when the consumer 12 wishes to render the particular scene 84 that includes a character corresponding to the model built.

The augmentation service 22 may further determine a time cycle that is to correspond to a particular scene 86 of the media content 14. For example, the consumer 12 may have a favorite scene that the consumer 12 wishes to activate (e.g., an asynchronous interaction), which may be replayed even when the media content 14 is not presently playing. In one example, the consumer 12 may configure the time cycle to specify that the particular scene 86 will play at a particular time (e.g., 4 pm when I arrive home, etc.). The time cycle may also indicate a time to live for the particular scene 86 (e.g., a timeout for activity after scene is played, etc.). The time cycle may be selected by, for example, the consumer 12, the content provider 20, the augmentation service 22 (e.g., machine learning, history data, etc.), and so on.

The augmentation service 22 may further detect a sequence that is to correspond to a particular scene 88 to be looped. For example, the consumer 12 may have a favorite scene that the consumer 12 wishes to activate (e.g., an asynchronous interaction), which may be re-queued and/or replayed in a loop to allow the consumer 12 to observe the particular scene 88 repeatedly. In one example, the particular scene 88 may be looped based on a sequence from the consumer 12. Thus, implementation of a spatial relationship involving a real object, such as the physical 3D play space 74 and/or the figure 72, may cause the particular scene 88 to loop, implementation of an action involving a real object may cause the particular scene 88 to loop, speaking a line from the particular scene 88 in a particular area of the physical space 18 may cause the particular scene 88 to loop, and so on. In another example, the particular scene 88 may be looped using a time cycle (e.g., period of time at which loop begins or ends, loop number, etc.).

The augmentation service 22 may further identify that a product from a particular scene 90 is absent from the physical 3D play space 74 and may recommend the product to the consumer 12. In one example, a particular interaction of a character 92 in the particular scene 90, that corresponds to the figure 72, with one other character 94 in the particular scene 90 cannot be emulated in the physical 3D play space 74 when a figure corresponding to the other character 94 is absent from the physical 3D play space 74. The augmentation service 22 may check the physical space 18 to determine whether the figure corresponding to the other character 94 is present and/or whether there are any building blocks to build a model of the figure (e.g., via an identification code, via object recognition, etc.). If the figure corresponding to the other character 94 is absent and/or cannot be built, the augmentation service 22 may render an advertisement 96 to offer the product (e.g., the figure, building blocks, etc.) that is absent from the physical space 18. Thus, any or all of scenes 76, 78, 80, 84, 86, 88, 90 may refer to an augmented scene (e.g., visual augmentation, temporal augmentation, audio augmentation, etc.) that is rendered to augment a user experience, such as the experience of the consumer 12.

While examples provide various features of the system 10 for illustration purposes, it should be understood that one or more features of the system 10 may reside in the same and/or different physical and/or virtual locations, may be combined, omitted, bypassed, re-arranged, and/or be utilized in any order. Moreover, any or all features of the system 10 may be automatically implemented (e.g., without human intervention, etc.).

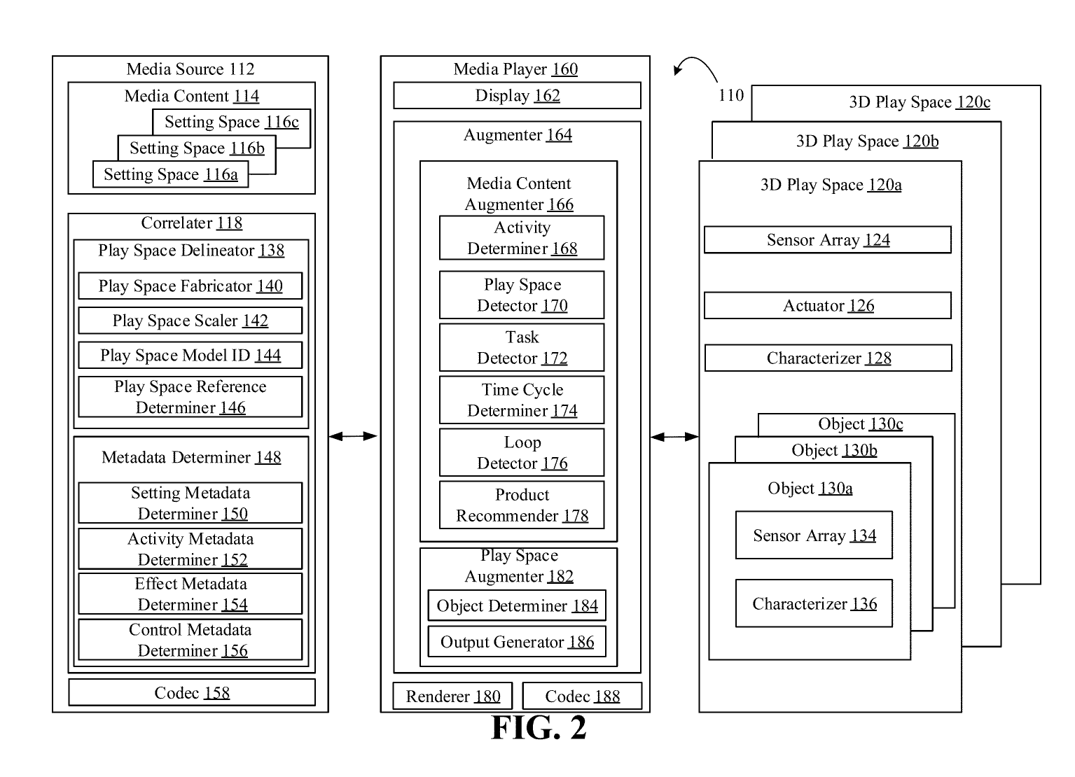

FIG. 2 shows an augmentation service 110 to augment a user experience according to an embodiment. The augmentation service 110 may have logic (e.g., logic instructions, configurable logic, fixed-functionality logic hardware, etc.) configured to implement any of the herein mentioned technologies including, for example, to correlate, to augment, to delineate, to determine metadata, to encode, to render, and so on. Thus, the augmentation service 110 may include the same functionality as the augmentation service 22 of the system 10 (FIGS. 1A-1C), discussed above.

In the illustrated example, the augmentation service 110 includes a media source 112 that provides media content 114. The media source 112 may include, for example, a production company that generates the media content 114, a broadcast network that airs the media content 114, an online content provider that streams the media content 114, a server (e.g., cloud-computing server, etc.) that stores the media content 114, and so on. In addition, the media content 114 may include a live TV show, a pre-recorded TV show, a video streamed from an online content provider, a video being played from a storage medium, a music concert, content including a virtual character, content including a real character, etc. In the illustrated example, the media content 114 includes setting spaces 116 (116a-116c) such as a real set and/or a real shooting location of a TV show, a virtual set and/or a virtual location of a TV show, and so on.

The media source 112 further includes a correlater 118 to correlate physical three-dimensional (3D) play spaces 120 (120a-120c) and the setting spaces 116. Any or all of the physical 3D play spaces 120 may be a real physical space (e.g., a bedroom, a family room, etc.), a real object in a real physical space that accommodates a real object and/or a virtual object (e.g., a toy, a model, etc.), and so on. In the illustrated example, the physical 3D play space 120a includes communication functionality to communicate with the media source 112 (e.g., via a communication link, etc.), a sensor array 124 to capture sensor data for the physical 3D play space 120a (e.g., user activity, spatial relationships, object actions, models, images, audio, identifiers, etc.), an actuator 126 to actuate output devices (e.g., projectors, speakers, lighting controllers, etc.) for the physical 3D play space 120a, and a characterizer 128 to provide a characteristic for the physical 3D play space 120a (e.g., an RF identification code, dimensions, etc.).

The physical 3D play space 120a further accommodates a plurality of objects 130 (130a-130c). Any or all of the plurality of objects 130 may include a toy figure (e.g., a toy action figure, a doll, etc.), a toy automobile (e.g., a toy car, etc.), a toy dwelling (e.g., a dollhouse, a base, etc.), and so on. In the illustrated example, the object 130a includes communication functionality to communicate with the media source 112 (e.g., via a communication link, etc.), a sensor array 134 to capture sensor data for the object 130a (e.g., user activity, spatial relationships, object actions, models, images, audio, identifiers, etc.), and a characterizer 136 to provide a characteristic for the object 130a (e.g., an RF identification code, dimensions, etc.).

The correlater 118 may communicate with the physical 3D play space 120a to map (e.g., 1:1 spatial mapping, etc.) the spaces 120a, 116a. For example, the correlater 118 may receive a characteristic from the characterizer 128 and map the physical 3D play space 120a with the setting space 116a based on the received characteristic. The correlater 118 may, for example, implement object recognition to determine whether a characteristic may be matched to the setting space 116a (e.g., a match threshold is met, etc.), may analyze an identifier from the physical 3D play space 120a to determine whether an object (e.g., a character, etc.) may be matched to the setting space 116a, etc.

Additionally, a play space delineator 138 may delineate the physical 3D play space 120a to allow the correlater 118 to correlate the spaces 120a, 116a. For example, a play space fabricator 140 may fabricate the physical 3D play space 120a to emulate the setting space 116a. At fabrication time, for example, the media source 112 (e.g., a licensee, a manufacturer, etc.) may link the physical 3D play space 120a with the setting space 116a (e.g., using identifiers, etc.). In addition, a play space scaler 142 may scale a dimension of the physical 3D play space 120a with a dimension of the setting space 116a to allow for correlation between the spaces 120a, 116a (e.g., scale to match).

Moreover, a play space model identifier 144 may identify a model built by a consumer of the media content 114 to emulate an object in the setting space 116a, to emulate the setting space 116a, etc. Thus, for example, the object 130a in the play space 120a may be correlated with an object in the setting space 116a using object recognition, identifiers, a predetermined mapping (e.g., at fabrication time, etc.), etc. The physical 3D play space 120a may also be constructed in real-time (e.g., a model constructed in real time, etc.) and correlated with the setting space 116a based on model identification, etc. In addition, a play space reference determiner 146 may determine a reference point of the physical 3D play space 120a about which a scene including the setting space 116a is to be played. Thus, the spaces 120a, 116a may be correlated using data from the sensor array 124 to detect an object (e.g., a fixture, etc.) in the physical 3D play space 120a about which a scene including the setting space 116a is to be played.

The correlater 118 further includes a metadata determiner 148 to determine metadata to correlate the spaces 120a, 116a. For example, a setting metadata determiner 150 may determine setting metadata for the setting space 116a including setting dimensions, colors, lighting, etc. An activity metadata determiner 152 may determine activity metadata for a character in the setting space 116a including movements, actions, spatial relationships, etc. In addition, an effect metadata determiner 154 may determine a special effect for the setting space 116a including thunder, rain, snow, engine rev, etc.

Also, a control metadata determiner 156 may determine control metadata for an instruction to be issued to a consumer, such as a prompt, an indication that rendering of the media content 114 is to pause when the prompt is issued, an indication that rendering of the media content 114 is to resume when a task is complete, and so on. Thus, the correlator 118 may correlate the spaces 120a, 116a using metadata from the metadata determiner 148, play space delineation from the play space delineator 138, sensor data from the sensor arrays 124, 134, characterization data from the characterizers 128, 136, etc. The data from the media source 112 (e.g., metadata, etc.) may be encoded by a codec 158 into the media content 114 for storage, for broadcasting, for streaming, etc.

In the illustrated example, the augmentation service 110 includes a media player 160 having a display 162 (e.g., a liquid crystal display, a light emitting diode display, a transparent display, etc.) to display the media content 14. In addition, media player 160 includes an augmenter 164 to augment a user experience. The augmenter 164 may augment a user experience based on, for example, metadata, play space delineation, sensor data, characterization data, and so on. In this regard, progression of the media content 114 may influence the physical 3D play spaces 120 and/or activities in the physical 3D play spaces 120 may influence the media content 114.

For example, a media content augmenter 166 may augment the media content based on a change in the physical 3D play space 120a. An activity determiner 168 may, for example, determine a spatial relationship and/or an activity involving the object 130a in the physical 3D play space 120a that is to correspond to a first scene or a second scene including the setting 116a based on, e.g., activity metadata from the activity metadata determiner 152, sensor data from the sensor arrays 124, 134, characterization data from the characterizers 128, 136, etc. Thus, a renderer 180 may render the first scene when the spatial relationship involving the real object is encountered to augment a user experience. In addition, the renderer 180 may render the second scene when the action involving the real object is encountered to augment user experience.

A play space detector 170 may detect a physical 3D play space that is built and that is to correspond to a third scene including the setting 116a (to be rendered) based on, e.g., play space delineation data from the play space delineator 138, sensor data from the sensor arrays 124, 134, characterization data from the characterizers 128, 136, etc. Thus, the renderer 180 may render the third scene when the physical 3D play space is encountered to augment a user experience. A task detector 172 may detect that a task of an instruction is to be accomplished that is to correspond to a fourth scene including the setting 116a (to be rendered) based on, e.g., control metadata from the control metadata determiner 156, sensor data from the sensor arrays 124, 134, characterization data from the characterizers 128, 136, etc. Thus, the renderer 180 may render the fourth scene when the task is to be accomplished to augment a user experience.

Moreover, a time cycle determiner 174 may determine a time cycle that is to correspond to a fifth scene including the setting 116a (to be rendered) based on, e.g., the activity metadata from the activity metadata determiner 152, sensor data from the sensor arrays 124, 134, characterization data from the characterizers 128, 136, etc. Thus, the renderer 180 may render the fifth scene when the period of time of the time cycle is encountered to augment a user experience. A loop detector 176 may detect a sequence (e.g., from a user, etc.) that is to correspond to a sixth scene including the setting 116a (to be rendered) to be looped based on, e.g., the activity metadata from the activity metadata determiner 152, sensor data from the sensor arrays 124, 134, characterization data from the characterizers 128, 136, etc. Thus, renderer 180 may render the sixth scene in a loop when the sequence is encountered to augment a user experience.

Additionally, a product recommender 178 may recommend a product that is to correspond to a seventh scene including the setting 116a (to be rendered) and that is to be absent from the physical 3D play space 120a based on, e.g., activity metadata from the activity metadata determiner 152, sensor data from the sensor arrays 124, 134, characterization data from the characterizers 128, 136, etc. Thus, the renderer 180 may render the product recommendation with the seventh scene when absence of the product is encountered to augment a user experience.

The augmenter 164 further includes a play space augmenter 182 to augment the physical 3D play space 120a based on a change in the setting space 116a. For example, an object determiner 184 may detect a real object in the physical 3D play space based on, e.g., the sensor data from the sensor arrays 124, 134, characterization data from the characterizers 128, 136, etc. In addition, an output generator 186 may generate an observable output in the physical 3D play space 120a that may emulate the change in the setting space 116a based on, e.g., the setting metadata from the setting metadata determiner 150, the activity metadata from the activity metadata determiner 152, the effect metadata from the effect metadata determiner 154, the actuators 126, 134, and so on. Additionally, the output generator 186 may generate an observable output in the physical 3D play space 120a that may be involved in satisfying an instruction of the media content 114 based on, e.g., the setting metadata from the setting metadata determiner 150, the activity metadata from the activity metadata determiner 152, the effect metadata from the effect metadata determiner 154, control metadata from the control metadata determiner 156, actuators 126, 134, and so on. In one example, the media player 160 includes a codec 188 to decode the data encoded in the media content 114 (e.g., metadata, etc.) to augment a user experience.

While examples provide various components of the augmentation service 110 for illustration purposes, it should be understood that one or more components of the augmentation service 110 may reside in the same and/or different physical and/or virtual locations, may be combined, omitted, bypassed, re-arranged, and/or be utilized in any order. Moreover, any or all components of the augmentation service 110 may be automatically implemented (e.g., without human intervention, etc.).

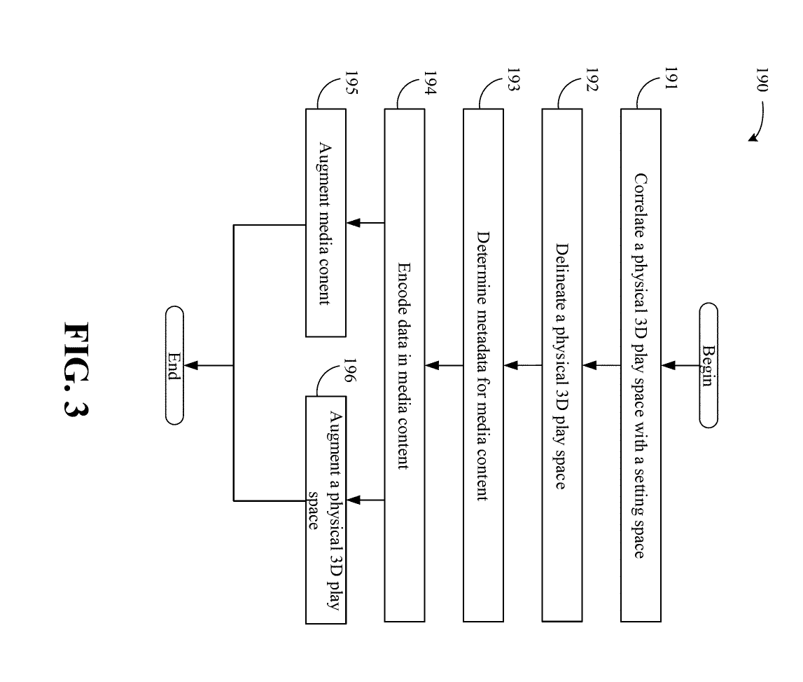

Turning now to FIG. 3, a method 190 is shown to augment a user experience according to an embodiment. The method 190 may be implemented via the system 10 and/or the augmentation service 22 (FIGS. 1A-1C), and/or the augmentation service 110 (FIG. 2), already discussed. The method 190 may be implemented as a module or related component in a set of logic instructions stored in a non-transitory machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality hardware logic using circuit technology such as, for example, application specific integrated circuit (ASIC), complementary metal oxide semiconductor (CMOS) or transistor-transistor logic (TTL) technology, or any combination thereof.

For example, computer program code to carry out operations shown in the method 190 may be written in any combination of one or more programming languages, including an object oriented programming language such as JAVA, SMALLTALK, C++ or the like and conventional procedural programming languages, such as the “C” programming language or similar programming languages. Additionally, logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Illustrated processing block 191 provides for correlating a physical three-dimensional (3D) play space and a setting space. For example, block 191 may implement a spatial mapping, object recognition, utilize identifiers, etc., to correlate the physical 3D play space and the setting space of media content. Illustrated processing block 192 provides for delineating a physical 3D play space, which may be used by block 191 to correlate spaces, objects, etc. In one example, block 192 may fabricate the physical 3D play space to emulate the setting space. Block 192 may also scale a dimension of the physical 3D play space with a dimension of the setting space. Block 192 may further identify a model built by a consumer of the media content to emulate an object in the setting space, to emulate the setting space, and so on. Additionally, block 192 may determine a reference point of the physical 3D play space about which a scene including the setting space is to be played.

Illustrated processing block 193 provides for determining metadata for media content, which may be used by block 191 to correlate spaces, objects, etc. Block 193 may, for example, determine setting metadata for the setting space. Block 193 may also determine activity metadata for a character in the setting space. In addition, block 193 may determine a special effect for the setting space. Block 193 may also determine control metadata for an instruction to be issued to a consumer of the media content. Illustrated processing block 194 provides for encoding data in media content (e.g., metadata, etc.). Block 194 may, for example, encode the setting metadata in the media content, the activity metadata in the media content, the effect metadata in the media content, the control metadata in the media content, and so on. In addition, block 194 may encode the data on a per-scene basis (e.g., a frame basis, etc.).

Illustrated processing block 195 provides for augmenting media content. In one example, block 195 may augment the media content based on a change in the physical 3D play space. The change in the physical 3D play space may include spatial relationships of objects, introduction of objects, user actions, building models, and so on. Block 195 may, for example, determine a spatial relationship involving a real object in the physical 3D play space that is to correspond to a first scene. Block 195 may also determine an action involving the real object in the physical 3D play space that is to correspond to a second scene.

Block 195 may further detect a physical 3D play space that is built and that is to correspond to a third scene. Additionally, block 195 may detect that a task of an instruction is to be accomplished that is to correspond to a fourth scene. In addition, block 195 may determine a time cycle that is to correspond to a fifth scene. Block 195 may also detect a sequence that is to correspond to a sixth scene to be looped. Block 195 may further recommend a product that is to correspond to a seventh scene and that is to be absent from the physical 3D play space.

Block 195 may render the first scene when the spatial relationship involving the real object is encountered to augment a user experience. Block 195 may also render the second scene when the action involving the real object is encountered to augment a user experience. Block 195 may further render the third scene when the physical 3D play space is encountered to augment a user experience. Additionally, block 195 may render the fourth scene when the task is to be accomplished to augment a user experience. In addition, block 195 may render the fifth scene when the period of time of the time cycle is encountered to augment a user experience. Block 195 may also render the sixth scene in a loop when the sequence is encountered to augment a user experience. In addition, block 195 may render the product recommendation with the seventh scene when absence of the product is encountered to augment a user experience.

Illustrated processing block 196 provides for augmenting a physical 3D play space. In one example, block 196 may augment the physical 3D play space based on a change in the setting space. The change in the setting space may include, for example, introduction of characters, action of characters, spatial relationships of objects, effects, prompts, progression of a scene, and so on. Block 196 may, for example, detect a real object in the physical 3D play space. For example, block 196 may determine the real object is introduced at a particular area of the physical 3D play space that is to correspond to a particular area of the setting space. Block 196 may also generate an observable output in the physical 3D play space that is to emulate the change in the setting space to augment the user experience. For example, block 196 may generate an action corresponding to an activity of the particular area of the setting space (e.g., effects, object action, etc.) that is to be rendered as an observable output in the physical 3D play space to emulate the activity in the particular area of the setting space.

Block 196 may further generate an observable output in the physical 3D play space that is to be involved in satisfying an instruction of the media content to augment a user experience. For example, block 196 may generate a virtual object, corresponding to the instruction of the media content that is to be rendered as an observable output in the physical 3D play space, which is involved in satisfying the instruction. Thus, a user experience may be augmented, wherein the progression of the media content may influence the physical 3D play space and wherein activity in the physical 3D play space may influence the media content.

While independent blocks and/or a particular order has been shown for illustration purposes, it should be understood that one or more of the blocks of the method 190 may be combined, omitted, bypassed, re-arranged, and/or flow in any order. Moreover, any or all blocks of the method 190 may be automatically implemented (e.g., without human intervention, etc.).

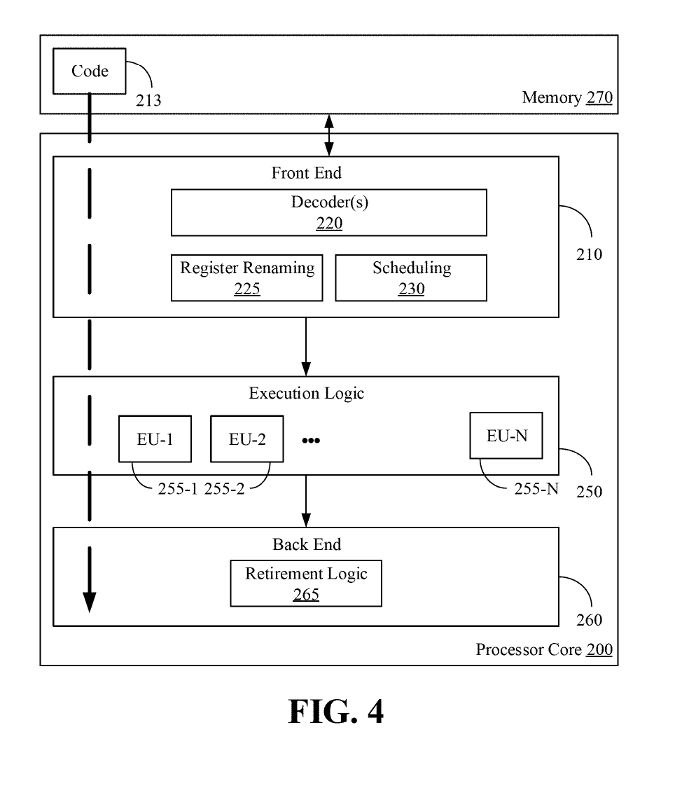

FIG. 4 shows a processor core 200 according to one embodiment. The processor core 200 may be the core for any type of processor, such as a micro-processor, an embedded processor, a digital signal processor (DSP), a network processor, or other device to execute code. Although only one processor core 200 is illustrated in FIG. 4, a processing element may alternatively include more than one of the processor core 200 illustrated in FIG. 4. The processor core 200 may be a single-threaded core or, for at least one embodiment, the processor core 200 may be multithreaded in that it may include more than one hardware thread context (or “logical processor”) per core.

FIG. 4 also illustrates a memory 270 coupled to the processor core 200. The memory 270 may be any of a wide variety of memories (including various layers of memory hierarchy) as are known or otherwise available to those of skill in the art. The memory 270 may include one or more code 213 instruction(s) to be executed by the processor core 200, wherein the code 213 may implement the system 10 and/or the augmentation service 22 (FIGS. 1A-1C), the augmentation service 110 (FIG. 2), and/or the method 190 (FIG. 3), already discussed. The processor core 200 follows a program sequence of instructions indicated by the code 213. Each instruction may enter a front end portion 210 and be processed by one or more decoders 220. The decoder 220 may generate as its output a micro operation such as a fixed width micro operation in a predefined format, or may generate other instructions, microinstructions, or control signals which reflect the original code instruction. The illustrated front end portion 210 also includes register renaming logic 225 and scheduling logic 230, which generally allocate resources and queue the operation corresponding to the convert instruction for execution.

The processor core 200 is shown including execution logic 250 having a set of execution units 255-1 through 255-N. Some embodiments may include a number of execution units dedicated to specific functions or sets of functions. Other embodiments may include only one execution unit or one execution unit that can perform a particular function. The illustrated execution logic 250 performs the operations specified by code instructions.

After completion of execution of the operations specified by the code instructions, back end logic 260 retires the instructions of the code 213. In one embodiment, the processor core 200 allows out of order execution but requires in order retirement of instructions. Retirement logic 265 may take a variety of forms as known to those of skill in the art (e.g., re-order buffers or the like). In this manner, the processor core 200 is transformed during execution of the code 213, at least in terms of the output generated by the decoder, the hardware registers and tables utilized by the register renaming logic 225, and any registers (not shown) modified by the execution logic 250.

Although not illustrated in FIG. 4, a processing element may include other elements on chip with the processor core 200. For example, a processing element may include memory control logic along with the processor core 200. The processing element may include I/O control logic and/or may include I/O control logic integrated with memory control logic. The processing element may also include one or more caches.

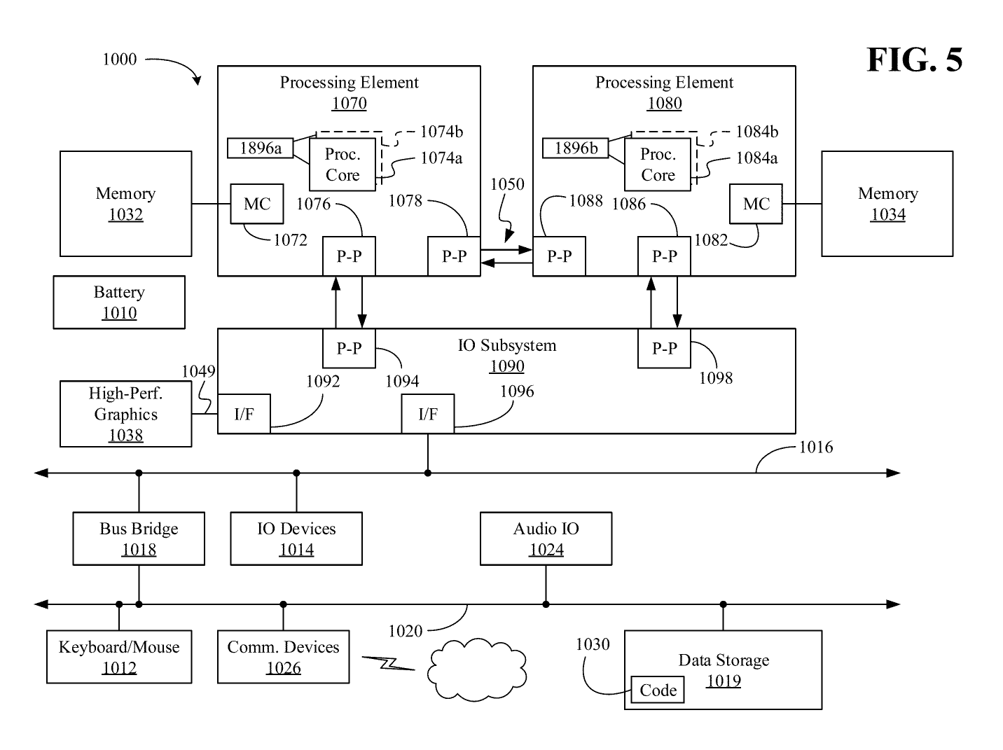

Referring now to FIG. 5, shown is a block diagram of a computing system 1000 embodiment in accordance with an embodiment. Shown in FIG. 5 is a multiprocessor system 1000 that includes a first processing element 1070 and a second processing element 1080. While two processing elements 1070 and 1080 are shown, it is to be understood that an embodiment of the system 1000 may also include only one such processing element.

The system 1000 is illustrated as a point-to-point interconnect system, wherein the first processing element 1070 and the second processing element 1080 are coupled via a point-to-point interconnect 1050. It should be understood that any or all of the interconnects illustrated in FIG. 5 may be implemented as a multi-drop bus rather than point-to-point interconnect.

As shown in FIG. 5, each of processing elements 1070 and 1080 may be multicore processors, including first and second processor cores (i.e., processor cores 1074a and 1074b and processor cores 1084a and 1084b). Such cores 1074a, 1074b, 1084a, 1084b may be configured to execute instruction code in a manner similar to that discussed above in connection with FIG. 4.

Each processing element 1070, 1080 may include at least one shared cache 1896a, 1896b. The shared cache 1896a, 1896b may store data (e.g., instructions) that are utilized by one or more components of the processor, such as the cores 1074a, 1074b and 1084a, 1084b, respectively. For example, the shared cache 1896a, 1896b may locally cache data stored in a memory 1032, 1034 for faster access by components of the processor. In one or more embodiments, the shared cache 1896a, 1896b may include one or more mid-level caches, such as level 2 (L2), level 3 (L3), level 4 (L4), or other levels of cache, a last level cache (LLC), and/or combinations thereof.

While shown with only two processing elements 1070, 1080, it is to be understood that the scope of the embodiments are not so limited. In other embodiments, one or more additional processing elements may be present in a given processor. Alternatively, one or more of processing elements 1070, 1080 may be an element other than a processor, such as an accelerator or a field programmable gate array. For example, additional processing element(s) may include additional processors(s) that are the same as a first processor 1070, additional processor(s) that are heterogeneous or asymmetric to processor a first processor 1070, accelerators (such as, e.g., graphics accelerators or digital signal processing (DSP) units), field programmable gate arrays, or any other processing element. There can be a variety of differences between the processing elements 1070, 1080 in terms of a spectrum of metrics of merit including architectural, micro architectural, thermal, power consumption characteristics, and the like. These differences may effectively manifest themselves as asymmetry and heterogeneity amongst the processing elements 1070, 1080. For at least one embodiment, the various processing elements 1070, 1080 may reside in the same die package.

The first processing element 1070 may further include memory controller logic (MC) 1072 and point-to-point (P-P) interfaces 1076 and 1078. Similarly, the second processing element 1080 may include a MC 1082 and P-P interfaces 1086 and 1088. As shown in FIG. 5, MC's 1072 and 1082 couple the processors to respective memories, namely a memory 1032 and a memory 1034, which may be portions of main memory locally attached to the respective processors. While the MC 1072 and 1082 is illustrated as integrated into the processing elements 1070, 1080, for alternative embodiments the MC logic may be discrete logic outside the processing elements 1070, 1080 rather than integrated therein.

The first processing element 1070 and the second processing element 1080 may be coupled to an I/O subsystem 1090 via P-P interconnects 1076 1086, respectively. As shown in FIG. 5, the I/O subsystem 1090 includes P-P interfaces 1094 and 1098. Furthermore, I/O subsystem 1090 includes an interface 1092 to couple I/O subsystem 1090 with a high performance graphics engine 1038. In one embodiment, bus 1049 may be used to couple the graphics engine 1038 to the I/O subsystem 1090. Alternately, a point-to-point interconnect may couple these components.

In turn, I/O subsystem 1090 may be coupled to a first bus 1016 via an interface 1096. In one embodiment, the first bus 1016 may be a Peripheral Component Interconnect (PCI) bus, or a bus such as a PCI Express bus or another third generation I/O interconnect bus, although the scope of the embodiments are not so limited.

As shown in FIG. 5, various I/O devices 1014 (e.g., cameras, sensors, etc.) may be coupled to the first bus 1016, along with a bus bridge 1018 which may couple the first bus 1016 to a second bus 1020. In one embodiment, the second bus 1020 may be a low pin count (LPC) bus. Various devices may be coupled to the second bus 1020 including, for example, a keyboard/mouse 1012, communication device(s) 1026 (which may in turn be in communication with a computer network), and a data storage unit 1019 such as a disk drive or other mass storage device which may include code 1030, in one embodiment. The illustrated code 1030 may implement the system 10 and/or the augmentation service 22 (FIGS. 1A-1C), the augmentation service 110 (FIG. 2), and/or the method 190 (FIG. 3), already discussed. Further, an audio I/O 1024 may be coupled to second bus 1020 and a battery 1010 may supply power to the computing system 1000.

Note that other embodiments are contemplated. For example, instead of the point-to-point architecture of FIG. 5, a system may implement a multi-drop bus or another such communication topology. Also, the elements of FIG. 5 may alternatively be partitioned using more or fewer integrated chips than shown in FIG. 5.

### ADDITIONAL NOTES AND EXAMPLES

Example 1 may include an apparatus to augment a user experience comprising a correlater, implemented at least partly in one or more of configurable logic or fixed functionality logic hardware, to correlate a physical three-dimensional (3D) play space and a setting space of media content, and an augmenter including one or more of, a media content augmenter, implemented at least partly in one or more of configurable logic or fixed functionality logic hardware, to augment the media content based on a change in the physical 3D play space, or a play space augmenter, implemented at least partly in one or more of configurable logic or fixed functionality logic hardware, to augment the physical 3D play space based on a change in the setting space.

Example 2 may include the apparatus of Example 1, wherein the correlater includes a play space delineator to delineate the physical 3D play space.

Example 3 may include the apparatus of any one of Examples 1 to 2, wherein the correlater includes a metadata determiner to determine metadata for the setting space.

Example 4 may include the apparatus of any one of Examples 1 to 3, further including a codec to encode the metadata in the media content.

Example 5 may include the apparatus of any one of Examples 1 to 4, wherein the media content augmenter includes one or more of, an activity determiner to determine one or more of a spatial relationship involving a real object in the physical 3D play space or an action involving the real object, a play space detector to detect a model to build the physical 3D play space, a task detector to detect that a task of an instruction is to be accomplished, a time cycle determiner to determine a time cycle, a loop detector to detect a sequence to trigger a scene loop, or a product recommender to recommend a product that is to be absent from the physical 3D play space.

Example 6 may include the apparatus of any one of Examples 1 to 5, further including a renderer to render an augmented scene.

Example 7 may include the apparatus of any one of Examples 1 to 6, wherein the play space augmenter includes an object determiner to determine a real object is introduced at a particular area of the physical 3D play space that is to correspond to a particular area of the setting space.

Example 8 may include the apparatus of any one of Examples 1 to 7, wherein the play space augmenter includes an output generator to generate an observable output in the physical 3D play space.

Example 9 may include at least one computer readable storage medium comprising a set of instructions, which when executed by a processor, cause the processor to correlate a physical three-dimensional (3D) play space and a setting space of media content, and augment one or more of the media content based on a change in the physical 3D play space or the physical 3D play space based on a change in the setting space.

Example 10 may include the at least one computer readable storage medium of Example 9, wherein the instructions, when executed, cause the processor to delineate the physical 3D play space.

Example 11 may include the at least one computer readable storage medium of any one of Examples 9 to 10, wherein the instructions, when executed, cause the processor to determine metadata for the setting space.

Example 12 may include the at least one computer readable storage medium of any one of Examples 9 to 11, wherein the instructions, when executed, cause the processor to encode the metadata in the media content.

Example 13 may include the at least one computer readable storage medium of any one of Examples 9 to 12, wherein the instructions, when executed, cause the processor to determine one or more of a spatial relationship involving a real object in the physical 3D play space or an action involving the real object, detect a model to build the physical 3D play space, detect that a task of an instruction is to be accomplished, determine a time cycle, detect a sequence to trigger a scene loop, and/or recommend a product that is to be absent from the physical 3D play space.

Example 14 may include the at least one computer readable storage medium of any one of Examples 9 to 13, wherein the instructions, when executed, cause the processor to render an augmented scene.

Example 15 may include the at least one computer readable storage medium of any one of Examples 9 to 14, wherein the instructions, when executed, cause the processor to determine a real object is introduced at a particular area of the physical 3D play space that is to correspond to a particular area of the setting space.

Example 16 may include the at least one computer readable storage medium of any one of Examples 9 to 15, wherein the instructions, when executed, cause the processor to generate an observable output in the physical 3D play space.

Example 17 may include a method to augment a user experience comprising correlating a physical three-dimensional (3D) play space and a setting space of media content and augmenting one or more of the media content based on a change in the physical 3D play space or the physical 3D play space based on a change in the setting space.

Example 18 may include the method of Example 17, further including delineating the physical 3D play space.

Example 19 may include the method of any one of Examples 17 to 18, further including determining metadata for the setting space.

Example 20 may include the method of any one of Examples 17 to 19, further including encoding the metadata in the media content.

Example 21 may include the method of any one of Examples 17 to 20, further including determining one or more of a spatial relationship involving a real object in the physical 3D play space or an action involving the real object, detecting a model to build the physical 3D play space, detecting that a task of an instruction is to be accomplished, determining a time cycle, detecting a sequence to trigger a scene loop, and/or recommending a product that is to be absent from the physical 3D play space.

Example 22 may include the method of any one of Examples 17 to 21, rendering an augmented scene.

Example 23 may include the method of any one of Examples 17 to 22, further including determining a real object is introduced at a particular area of the physical 3D play space that is to correspond to a particular area of the setting space.

Example 24 may include the method of any one of Examples 17 to 23, further including generating an observable output in the physical 3D play space.

Example 25 may include an apparatus to augment a user experience comprising means for performing the method of any one of Examples 17 to 24.

Thus, techniques described herein provide for correlating physical 3D play spaces (e.g., a dollhouse, a child's bedroom, etc.) with spaces in media (e.g., a television show production set). The physical 3D play space may be created by a toy manufacturer, may be a space built by a user with building blocks or other materials, and so on. Self-detecting building models and/or use of cameras to detect built spaces may be implemented. In addition, embodiments provide for propagating corresponding changes among the physical spaces.

In one example, a character's bedroom in a TV show may have a corresponding room in a dollhouse that is located in a physical space of a viewer, and a program of instructions, created from the scene in media, may be downloaded to the dollhouse to augment user experience by modifying the behavior of the dollhouse. Metadata from a scene in media may, for example, be downloaded to the dollhouse to create a program of instructions that would determine the behavior of the dollhouse to operate as it does in the scene (e.g., the lights turn off when there is a thunderclap). TV shows and/or movies (and other media), for example, may be prepared with additional metadata that tracks actions of characters within the scenes. The metadata could be added with other kinds of metadata during production, or video analytics could be run on the video in post-production to estimate attributes such as proximity of characters to other characters and locations in the space.

Example metadata may include, for example, coordinates for each character, proximity of characters, apparent dimensions of room in scene, etc. Moreover, the relative movement of characters and/or other virtual objects within the media may be tracked relative to the size of the space and proximity of objects in the space. 3D and/or depth cameras used during filming of media could allow spatial information about physical spaces within the scene settings to be added to metadata of the video frames, which may allow for later matching and orientation of play structure spaces. The metadata may be include measurement information that is subsequently downscaled to match with expected measures of the play space, which may be built in correspondence to the settings in the media (e.g., the measures of one side of a room of a dollhouse would correspond to a wall of the scene/setting or a virtual version of that room in the media that is designed to match the perspective that may be in a doll house). For example, in some filming stages, some walls may not exist. Virtual media space may be explicitly defined by producers to correspond to the dollhouse or other play space for an animated series (e.g., with computer generated images).

Outputs to modify behaviors of physical 3D play spaces include haptic/vibration output, odor output, visual output, etc. In addition, the behaviors from the scene may continue after the scene has played on a timed cycle, and/or sensors may be used to sense objects (e.g., certain doll characters, etc.) to continue behaviors (e.g., of a dollhouse, etc.). Media may, for example, utilize sensors, actuators, etc., to render atmospheric conditions (e.g., rain, snow, etc.) from a specific scene, adding those effects to a corresponding group of toys or to another physical 3D play space (e.g., using a projector to show the condition in the dollhouse, in a window of a room, etc.). Moreover, corresponding spaces in the toys could be activated (e.g., light up or play background music) as scenes change in the media being played (e.g., a scene in a house or car). New content may stream to the toys to allow the corresponding behaviors as media is cued up.

Moreover, sound effects and lighting effects from a show could display on/in/and around the dollhouse beyond just a thunderstorm and blinking lights. An entire mood of a scene from lighting, weather, actions of characters (e.g., tense, happy, sad, etc.) and/or setting of the content in the show could be displayed within the 3D play space (e.g., through color, sound, haptic feedback, odor, etc.) when content is playing. Sensors (e.g., of a toy such as a dollhouse) may also be used to directly detect sounds, video, etc., from the media (e.g., versus wireless communication from a media playing computing platform) to, e.g., determine the behavior of the 3D play space.

Embodiments further provide for allowing a user to carry out actions to activate or change media content. For example, specific instructions (e.g., an assigned mission) may be carried out to activate or change media content. In one example, each physical toy may report an ID that corresponds to a character in the TV show. When the TV show pauses, instructions could direct the viewer to assemble physical toys that match the physical space in the scene, and the system may monitor for completion of the instruction and/or guide the user in building it. The system may offer to sell any missing elements. Moreover, the system may track the position of the toys within play spaces.

The arrival or movement of a physical character in the physical 3D play space could switch the media to a different scene/setting, or the user may have to construct a particular element in an assigned way. “Play” with the dollhouse could even pause the story at a specific spot and then resume later when the child completes some mission (an assigned set of tasks).

In another example, embodiments may provide for content “looping” where a child may cause a scene to repeat based on an input. The child may, for example, move a “smart dog toy” in the dollhouse when the child finds a funny scene were a dog does some action, and the dog doing the action will repeat based on the movement of the toy in the 3D play space. In addition, actions carried out by a user may cause media to take divergent paths in non-linear content. For example, Internet broadcast entities may create shows that are non-linear and diverge with multiple endings, and media may be activated or changed based on the user inputs, such as voice inputs, gesture inputs, etc.

Embodiment may provide for allowing a user to build a space with building blocks and direct that the space correlate with a setting in the media, thus directing digital/electrical outputs in the real space to behave as the media scene (e.g., music or dialog being played). Building the 3D play space may be in response to specific instructions, as discussed above, and/or may be proactively initiated absent any prompt by the media content. In this regard, embodiments may provide for automatically determining that a particular space is being built to copy a scene/setting.

Embodiments may provide for redirecting media to play in the 3D play space (e.g., dollhouse, etc.) instead of the TV. For example, a modified media player may recognize that some audio tracks or sound effects should be redirected to the dollhouse. In response, a speaker of the dollhouse may play a doorbell sound rather than hearing it out a speaker of the TV and/or computer if a character in a story rings the doorbell.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the computing system within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” or “at least one of” may mean any combination of the listed terms. For example, the phrases “one or more of A, B or C” may mean A; B; C; A and B; A and C; B and C; or A, B and C. In addition, a list of items joined by the term “and so on” or “etc.” may mean any combination of the listed terms as well any combination with other terms.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

1. An apparatus comprising:
a correlater, implemented at least partly in one or more of configurable logic or fixed functionality logic hardware, to make a correlation between a physical three-dimensional (3D) play space and a setting space of media content, wherein the setting space is to include one or more of a set or a shooting location of one or more of a television program or a movie that is to be rendered via a computing platform physically co-located with a user, and
an augmenter including one or more of,
a media content augmenter, implemented at least partly in one or more of configurable logic or fixed functionality logic hardware, that augments the media content based on the correlation and a change in the physical 3D play space, or
a play space augmenter, implemented at least partly in one or more of configurable logic or fixed functionality logic hardware, that augments the physical 3D play space based on the correlation and a change in the setting space.

2. The apparatus of claim 1, wherein the correlater includes a play space delineator to delineate the physical 3D play space.

3. The apparatus of claim 1, wherein the correlater includes a metadata determiner to determine metadata for the setting space.

4. The apparatus of claim 3, further including a codec to encode the metadata in the media content.

5. The apparatus of claim 1, wherein the media content augmenter includes one or more of,
an activity determiner to determine one or more of a spatial relationship involving a real object in the physical 3D play space or an action involving the real object,
a play space detector to detect a model to build the physical 3D play space,
a task detector to detect that a task of an instruction is to be accomplished,
a time cycle determiner to determine a time cycle,
a loop detector to detect a sequence to trigger a scene loop, or
a product recommender to recommend a product that is to be absent from the physical 3D play space.

6. The apparatus of claim 1, further including a renderer to render an augmented scene.

7. The apparatus of claim 1, wherein the play space augmenter includes an object determiner to determine a real object is introduced at a particular area of the physical 3D play space that is to correspond to a particular area of the setting space.

8. The apparatus of claim 1, wherein the play space augmenter includes an output generator to generate an observable output in the physical 3D play space.

9. At least one non-transitory computer readable storage medium comprising a set of instructions, which when executed by a processor, cause the processor to:
make a correlation between a physical three-dimensional (3D) play space and a setting space of media content, wherein the setting space is to include one or more of a set or a shooting location of one or more of a television program or a movie that is to be rendered via a computing platform physically co-located with a user; and
augment one or more of the media content based on the correlation and a change in the physical 3D play space or the physical 3D play space based on the correlation and a change in the setting space.

10. The at least one computer readable storage medium of claim 9, wherein the instructions, when executed, cause the processor to delineate the physical 3D play space.

11. The at least one computer readable storage medium of claim 9, wherein the instructions, when executed, cause the processor to determine metadata for the setting space.

12. The at least one computer readable storage medium of claim 11, wherein the instructions, when executed, cause the processor to encode the metadata in the media content.

13. The at least one computer readable storage medium of claim 9, wherein the instructions, when executed, cause the processor to:
determine one or more of a spatial relationship involving a real object in the physical 3D play space or an action involving the real object;
detect a model to build the physical 3D play space;
detect that a task of an instruction is to be accomplished;
determine a time cycle;
detect a sequence to trigger a scene loop; and/or
recommend a product that is to be absent from the physical 3D play space.

14. The at least one computer readable storage medium of claim 9, wherein the instructions, when executed, cause the processor to render an augmented scene.

15. The at least one computer readable storage medium of claim 9, wherein the instructions, when executed, cause the processor to determine a real object is introduced at a particular area of the physical 3D play space that is to correspond to a particular area of the setting space.

16. The at least one computer readable storage medium of claim 9, wherein the instructions, when executed, cause the processor to generate an observable output in the physical 3D play space.

17. A method comprising:
making a correlation between a physical three-dimensional (3D) play space and a setting space of media content, wherein the setting space includes one or more of a set or a shooting location of one or more of a television program or a movie that is rendered via a computing platform physically co-located with a user; and
augmenting one or more of the media content based on the correlation and a change in the physical 3D play space or the physical 3D play space based on the correlation and a change in the setting space.

18. The method of claim 17, further including delineating the physical 3D play space.

19. The method of claim 17, further including determining metadata for the setting space.

20. The method of claim 19, further including encoding the metadata in the media content.

21. The method of claim 17, further including:
determining one or more of a spatial relationship involving a real object in the physical 3D play space or an action involving the real object;
detecting a model to build the physical 3D play space;
detecting that a task of an instruction is to be accomplished;
determining a time cycle;
detecting a sequence to trigger a scene loop; and/or
recommending a product that is to be absent from the physical 3D play space.

22. The method of claim 17, further including rendering an augmented scene.

23. The method of any one of claim 17, further including determining a real object is introduced at a particular area of the physical 3D play space that is to correspond to a particular area of the setting space.

24. The method of claim 17, further including generating an observable output in the physical 3D play space.
